(19) United States
(12) Patent Application Publication
(10) Pub. No.: US 2012/0163291 A1
(43) Pub. Date: Jun. 28, 2012

(54) Physical uplink control channel Interference Mitigation in heterogenous networks

(76) Inventors: Yuan Zhu, Beijing (CN); Xiangying Yang, Portland, OR (US); Qinghua Li, San Ramon, CA (US); Yujian Zhang, Beijing (CN)

(21) Appl. No.: 12/930,001

(22) Filed: Dec. 23, 2010

(51) Int. Cl. H04W 40/00

(52) U.S. Cl. 370/328

(57) ABSTRACT

In some embodiments, a wireless device comprises a baseband processor, a control module coupled to the signal processor and comprising logic to map a first set and at least one redundant set of physical uplink control channel (PUCCH) blocks into a subframe structure, wherein the at least one redundant set of PUCCH blocks is embedded in an interior section of the subframe, an RF modulator/demodulator coupled to the baseband processor to modulate/demodulate the PUCCH blocks for communication within a predetermined frequency range, and a transmitter to transmit the PUCCH blocks. Other embodiments may be described.

### BACKGROUND

Heterogenous wireless networks are wireless networks that provide network access using two or more different wireless protocols. By way of example, some wireless networks are beginning to incorporate femto access points (FAPs), which are lower power micro base stations (BSs) which typically operate in a licensed portion of the electromagnetic spectrum. Femto access points may be deployed in a local area to enhance wireless service coverage and/or performance in a wireless wide area network (WWAN). Femto access points may be deployed in buildings or other locations, such as at the edge of a network cell, in which performance of the wireless wide area network is degraded. Femto access points may be backhauled to the network via a broadband connection to the network, for example via a cable, fiber, and/or digital subscriber line, such that a client device connects to the network via the locally disposed femto access point rather than via a remotely disposed base station (BS) or a base transceiver station (BTS) of the network.

Wireless networking nodes commonly exchange control information between components in one or more control channels. By way of example, wireless networks which operate in accordance with various aspects of the Long Term Evolution (LTE) body of standards exchange certain control information between network nodes in a Physical Uplink Control Channel (PUCCH). For more detailed information reference can be made to 3GPP TS 36.211 V8.2.0 (2008-03), 3rd Generation Partnership Project; Technical Specification Group Radio Access Network; Evolved Universal Terrestrial Radio Access (E-UTRA); Physical Channels and Modulation (Release 8), the disclosure of which is incorporated herein by reference in its entirety.

Such control information is important to the interoperability of heterogeneous networks. Accordingly, techniques to mitigate interference in control channels in heterogeneous networks may find utility.

### BRIEF DESCRIPTION OF THE DRAWINGS

The detailed description is described with reference to the accompanying figures.

FIGS. 1A and 1B are a schematic illustration of a wireless wide area network, according to some embodiments.

FIG. 2 is a schematic illustration of a wireless networking station, according to some embodiments.

FIG. 3 is a schematic illustration of a wireless device according to some embodiments.

FIG. 4 is a flow diagram illustrating operations in a method to manage transmission power of a femto access point, according to some embodiments.

FIG. 5 is a schematic illustration of a subframe structure, according to some embodiments.

### DETAILED DESCRIPTION

Described herein are exemplary methods to manage mitigate interference in heterogenous networks. By way of example, the techniques described herein may be used to mitigate interference in the PUCCH between a femto access point and a WiMAX base station. In some embodiments uplink communications are structured to implement clustered single carrier frequency division multiple access (SC-FDMA) modulation techniques. In such embodiments interference may be mitigated by creating a second physical uplink control channel (PUCCH) block near the center of the bandwith allocated for the uplink connection.

In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlaying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

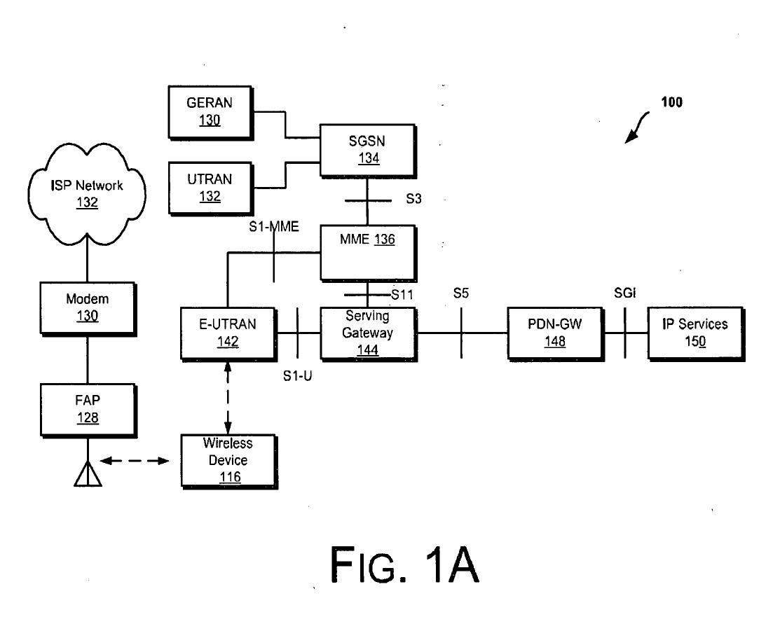

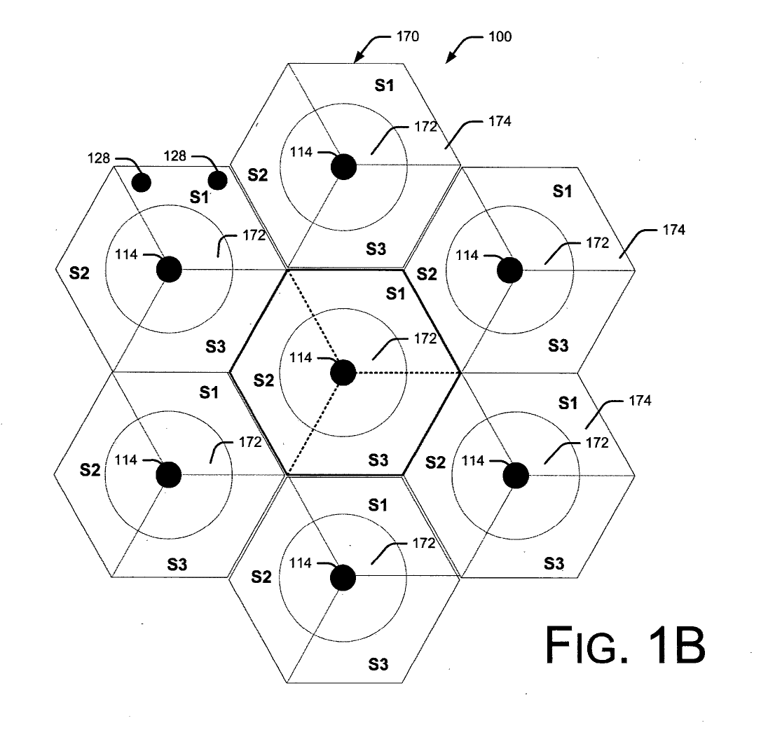

FIGS. 1A and 1B are a schematic illustration of a wireless wide area network, according to some embodiments. Referring now to FIG. 1, a block diagram of a wireless wide area network in accordance with one or more embodiments will be discussed. As shown in FIG. 1A, a block diagram of an architecture of a wireless network capable of implementing in accordance with one or more embodiments will be discussed. In one embodiment, FIG. 1A illustrates architectural enhancements of a 3GPP Enhanced Packet Core (EPC) 100. EPC is an architecture evolution of 3GPP systems being standardized as a part of 3GPP Release 8 and beyond. It should be noted that not all of the components of 3GPP EPC 100 are illustrated in FIG. 1A.

In one or more embodiments, a user equipment and/or wireless device 116 couples to an evolved-UTRAN (E-UTRAN) 142 which in turn couples to serving gateway 144. Serving gateway 144 couples to packet data network gateway (PDN Gateway) 148 which is coupled with Internet Protocol Services (IP Services) 150 to allow user equipment and/or mobile station 110 to connect to the internet, although the scope of the claimed subject matter is not limited in this respect.

E-UTRAN 142 couples to a mobility management entity (MME) 136 via an S1-MME interface, and the serving gateway 134 couples to the MME via an S11 interface. MME 136 couples to a Serving GPRS Support Node (SGSN) 134 via an S3 interface. To complete 3GPP network 300, SGSN 134 couples to GSM EDGE Radio Access Network (GERAN) 130 and to UMTS Terrestrial Radio Access Network (UTRAN) 132.

Wireless device 116 may couple to Internet 110 via a wireless communication link with femto access point (FAP) 128 rather than a wireless communication link with E-UTRAN 142. As shown in FIG. 1A, femto access point 128 comprises a lower power base station device designed enhance the coverage area for wireless devices 116 located at or near the edge, or outside of the coverage are of one or more E-UTRAN 142. Alternatively, femto access point 128 may increase performance of wireless devices located within buildings that may attenuate or otherwise interfere with wireless communications with E-UTRAN 142. In such an arrangement, wireless device 116 may communicate with femto access point 128 which is coupled to a modem 130 such as a cable modem, digital subscriber line (DSL) modem, or the like. Femto access point 128 may couple to network 100 via an Internet service provider (ISP) network 132 which may allow femto access point 128 to access the 3GPP network 100 and services via a gateway. As a result, wireless device 116 is capable of coupling to Internet 110 and/or to the services provided by WiMAX network such as, for example, software services, voice over internet protocol (VoIP) services, database access, and so on. Thus, a locally deployed femto access point 128 can enhance access of wireless device 116 to network 100 in situations where wireless device 116 may have difficulty communicating with E-UTRAN 142, although the scope of the claimed subject matter is not limited in this respect.

Referring now to FIG. 1B, in some embodiments the network 100 may be organized as a cellular network in which a number of cells 170. Each cell 170 is serviced by a base station 114 which may be disposed approximately in the center of the cell 170. In some embodiments the cell may be subdivided into sectors, designated S1, S2, and S3 in FIG. 1B. Typically, each sector covers a 120 degree angle of the cell 170. Various frequency allocation schemes may be implemented by the base stations 114 to reduce interference between adjacent cells 170. By way of example, cellular networks 100 may implement various frequency reuse schemes to reduce interference between adjacent cells.

A region surrounding the base station 114 may be described as the cell center 172. In practice, the region defined as the cell center 172 may be defined by signal strength characteristics rather than geographic boundaries. For example, the cell center 172 may be defined as the geographic region in which the signal strength of the signal from the base station 114 exceeds a minimum threshold. The strength of a signal from the base station 114 decays as the distance from the base station 114 increases. Thus, in practice the border defining the cell center 172 may expand or contract based on factor such as the transmission power implemented by the base station 114 at any particular point in time, geographic features, or physical obstacles in the communication path between a wireless device 116 and the base station 114. In addition, while the border defining the cell center 172 is depicted as a circle having a defined radius, one skilled in the art will recognize that the cell center may not be a uniform circle. Rather, the border may deviate as a function of transmission power, geographic features, physical obstacles, and the like.

The region outside the cell center 172 may be referred to as a cell edge 174. Again, the cell edge 174 may be defined by signal strength characteristics rather than geographic characteristics. For example, the cell edge 174 may be defined by the geographic region in which the signal strength of the signal from the base station 114 is below a threshold. A cell-edge may also be defined if signal-to-interference-plus-noise ratio is below a threshold. The SINR metric not only measures signal strength, but also interference levels at cell-edge (which can be quite high). When cell-edge is defined as users with SINR below a certain threshold, cell-center users are the remaining user associated with that BS.

One or more femto access points 128 may be positioned in the cells 170. As described above, a femto access point 128 may be positioned in an environment in which the signal from the base station 114 is degraded due to the environment (e.g., obstacles such as a building) or due to the distance from the base station 114 a wireless device 116 is located. For example, femto access points 128 may be located near the edge of a network cell 170 to bolster service quality of wireless devices 116 operating in a cell edge 174.

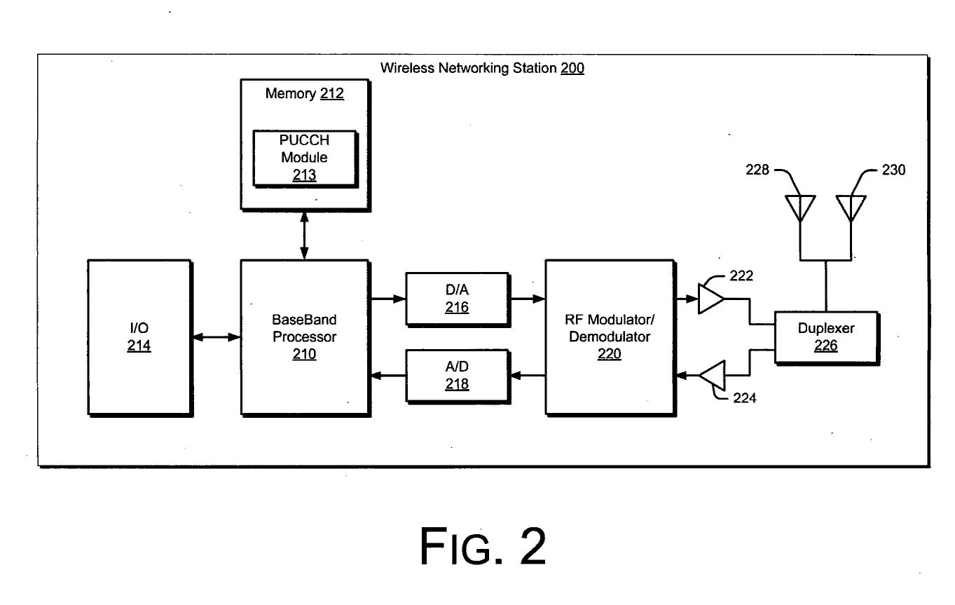

Referring now to FIG. 2, a block diagram of a wireless network station 200 in accordance with one or more embodiments will be discussed. FIG. 2 illustrates an example block diagram of wireless network station 200 which may be either a base station 114 or a femto access point 128 as shown in and described with respect to FIG. 1B, above. FIG. 2 depicts the major elements of an example wireless network station 200, however fewer or additional elements may be included in alternative embodiments in addition to various other elements that are not shown herein, and the scope of the claimed subject matter is not limited in these respects.

Wireless network station 200 may comprise a baseband processor 210 coupled to memory 212 for performing the control functions of femto access point 128. Input/output (I/O) block 214 may comprise various circuits for coupling femto access point 128 to one or more other devices. For example, I/O block 214 may include one or more Ethernet ports and/or one or more universal serial bus (USB) ports for coupling femto access point 128 to modem 130 or other devices. For wireless communication, femto access point 128 may further include a radio-frequency (RF) modulator/demodulator for modulating signals to be transmitted and/or for demodulating signals received via a wireless communication link. A digital-to-analog (D/A) converter 216 may convert digital signals from baseband processor 210 to analog signals for modulation and broadcasting by RF modulator/demodulator via analog and/or digital RF transmission techniques. Likewise, analog-to-digital (A/D) converter 218 may convert analog signals received and demodulated by RF modulator/demodulator 220 digital signals in a format capable of being handled by baseband processor 210. Power amplifier (PA) 222 transmits outgoing signals via one or more antennas 228 and/or 230, and low noise amplifier (LNA) 224 receives one or more incoming signals via antennas 228 and/or 230, which may be coupled via duplexer 226 to control such bidirectional communication. In one or more embodiments, wireless network station 200 may implement single input, single output (SISO) type communication, and in one or more alternative embodiments wireless network station 200 may implement multiple input, multiple output (MIMO) communications, although the scope of the claimed subject matter is not limited in these respects.

In some embodiments wireless networking station comprises a PUCCH module 213 which may implement operations in accordance with the description provided herein. In some embodiments the PUCCH module 213 may be implemented as logic instructions stored in the computer readable medium of memory 212. When executed by a processor, e.g., the baseband processor 210 or another processor in or coupled to access point 128, the control module may implement one or more operations to manage interference between a relay station 128 and a base station 114, or between a relay station and a neighboring relay station. In alternate embodiments the PUCCH module 213 may be implemented as hardwired logic circuitry which may be coupled to, or integrated with a processor such as baseband processor 210.

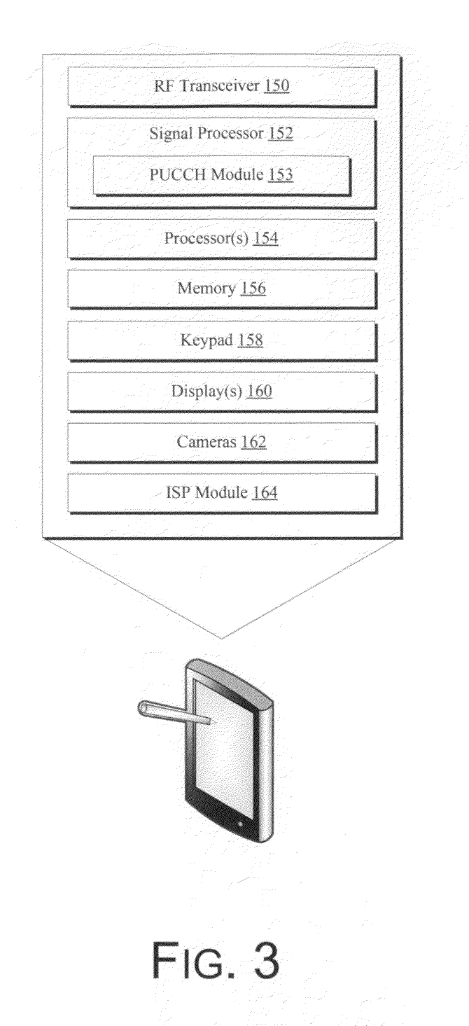

FIG. 3 is a schematic illustration of a wireless device 110 according to some embodiments. Referring to FIG. 3, in some embodiments wireless device 116 may be embodied as a mobile telephone, a personal digital assistant (PDA), a laptop computer, or the like. Electronic device 110 may include an RF transceiver 150 to transceive RF signals and a signal processing module 152 to process signals received by RF transceiver 150.

RF transceiver may implement a local wireless connection via a protocol such as, e.g., Bluetooth or 802.11x. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11 G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Wireless device 110 may further include one or more processors 154 and a memory module 156. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some embodiments, processor 154 may be one or more processors in the family of Intel® PXA27x processors available from Intel® Corporation of Santa Clara, Calif. Alternatively, other CPUs may be used, such as Intel's Itanium®, XEON™, ATOM™, and Celeron® processors. Also, one or more processors from other manufactures may be utilized. Moreover, the processors may have a single or multi core design. In some embodiments, memory module 156 includes random access memory (RAM); however, memory module 156 may be implemented using other memory types such as dynamic RAM (DRAM), synchronous DRAM (SDRAM), and the like.

Wireless device 110 may further include one or more input/output interfaces such as, e.g., a keypad 158 and one or more displays 160. In some embodiments electronic device 110 comprises one or more camera modules 162 and an image signal processor 164.

In some embodiments wireless device 110 may include PUCCH module 153 which structures a PUCCH to be transmitted from the wireless device to one of a femto access point 128 or a base station 114. PUCCH module 153 determines a number of clusters available in a clustered SC-FDMA access modulation scheme, then creates a PUCCH block and maps the PUCCH blocks into physical resource blocks available for the PUCCH. Further, in some embodiments the PUCCH module may evaluate feedback from the femto access point 128 or base station 114 and modify the number of reduant PUCCH blocks transmitted in accordance with the feedback. In the embodiment depicted in FIG. 3 the PUCCH module 153 is implemented as logic in the signal processor 152. In alternate embodiments interference measurement module 157 may be implemented as software or firmware executable on the processor(s) 154 or may be reduced to hardwired logic circuitry. The particular implementation of the PUCCH module 153 is not critical.

Referring briefly back to FIG. 2, in some embodiments wireless networking station 200 may include a PUCCH module 213 which may be implemented as logic instructions stored in the computer readable medium of memory 212. When executed by a processor, e.g., the baseband processor 210 or another processor in or coupled to access point 128, the PUCCH module may implement one or more operations to receive the PUCCH from wireless device 116 and provide feedback in accordance with the description provided herein.

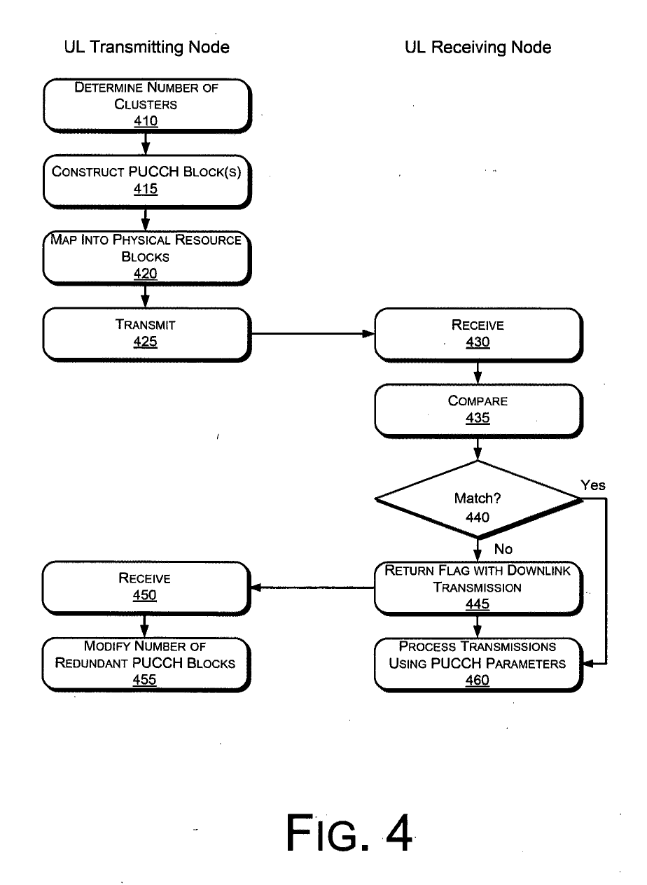

In some embodiments the respective PUCCH modules 153 and 213 implement techniques to manage communication between an uplink transmitting node and an uplink receiving node. In some embodiments communication from a wireless device 116 to a wireless networking station 200 may be referred to as “uplink” communication, while communication from a wireless networking station 200 to the wireless device 116 may be referred to as “downlink” communication. FIG. 4 is a flow diagram illustrating operations in a method to manage data transmission from a wireless device such as device 116, according to some embodiments. The operations of FIG. 4 are described with reference to wireless device 116 as the a uplink transmitting node and a base station 128 as an uplink receiving node. One skilled in the art will recognize that the uplink transmitting node may be a wireless device 116 or any device which generates or relays uplink communications. By way of example, some wireless networks utilize wireless relay stations to relay communications from a wireless device such as an uplink receiving node such as base station 128.

Referring now to FIG. 4, at operation 410 the PUCCH module 153 of the wireless device 116 determines a number of clusters used in the modulation scheme implemented by the wireless device 116. By way of example, in some embodiments the wireless device 116 implements a clustered SC-FDMA modulation scheme using at least two clusters.

At operation 415 the PUCCH module 153 constructs PUCCH blocks which define the PUCCH channel. In some embodiments the number of PUCCH blocks corresponds to the number of clusters used in the SC-FDMA modulation scheme. Thus, in a two-cluster modulation scheme two PUCCH blocks may be created. In an n-cluster modulation scheme, where n is greater than two, two or more PUCCH blocks may be created.

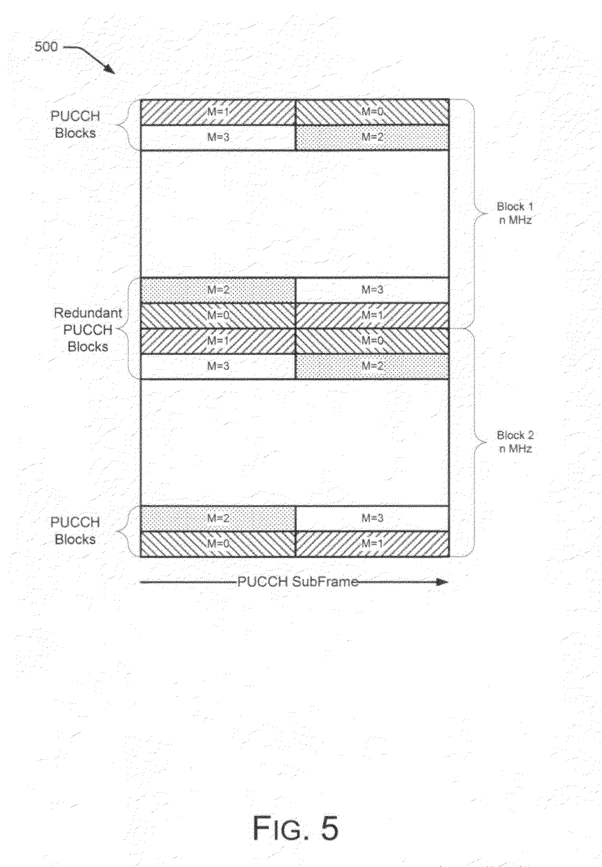

At operation 420 the PUCCH blocks are mapped into the physical resource blocks (PRBs) for transmission from the wireless device 116. Referring to FIG. 5, in some embodiments a PUCCH subframe 500 is created. The embodiment depicted in FIG. 5 illustrates a subframe 500 which may be implemented in a 2-cluster SC-FDMA modulation scheme. Thus the PUCCH subframe 500 has two blocks, each of which is allocated a defined bandwidth of n MHz in the transmission protocol. In some embodiments Block 1 may correspond to the PUCCH channel for the base station 116 while Block 2 may correspond to the PUCCH channel for a femto access point 128.

In some embodiments a redundant set of PUCCH blocks are mapped into an interior section of the PUCCH subframe 500. The specific location within the interior section is not critical. In the embodiment depicted in FIG. 5 the redundant set of PUCCH blocks is mapped into a region approximately in the center of the bandwidth allocated for the PUCCH subframe 500. Because the redundant set of PUCCH blocks are in the center of the allocated bandwidth, rather than at the edges, the redundant set of PUCCH blocks are less susceptible to interference generated by other wireless transmissions operating in the same geographic region and on the same frequency range. Thus, including a redundant set of PUCCH blocks in the center of a subframe 500 mitigates interference in the PUCCH channel between a base station 114 and a femto access point 128. At operation 425 the PUCCH is transmitted from the uplink transmitting node.

At operation 430 the PUCCH is received at the UL receiving node. By way of example a PUCCH transmission from a wireless device may be received at a femto access point 128 or a base station 114. In some embodiments the PUCCH module 213 in the uplink receiving node implements operations to assess the PUCCH data and provide a feedback signal to the uplink transmitting node. At operation 435 the uplink receiving node compares the data in the PUCCH control blocks. If at operation 440 there are discrepancies between the two data sets (i.e., if the data sets do not match) this indicates that interference is occurring in the transmission of the PUCCH data. In this case the PUCCH module 213 sets a flag to indicate that the PUCCH data does not match and returns (operation 445) the flag to the uplink transmitting node in a downlink transmission. The uplink receiving node may then continue to process transmissions using the PUCCH parameters (operation 460).

At operation 450 the uplink transmitting node receives the flag transmitted from the uplink receiving node. In response to receiving a flag, the uplink transmitting node may implement operations to modify a number of redundant PUCCH blocks included in the uplink transmission. By way of example, in embodiments in which the clustered SC-FDMA modulation scheme allocates sufficient bandwidth for multiple redundant PUCCH blocks the uplink transmitting node may add an additional set of redundant PUCCH blocks into the bandwidth allocated for the PUCCH subframe 500. T

Thus, operations 410-460 define a process by which an uplink transmitting node may transmit one or more redundant PUCCH blocks in an interior portion of the bandwidth allocation for the PUCCH in a given modulation scheme, and may modify the number of redundant PUCCH blocks in response to feedback from an uplink receiving node.

While particular terminology is used herein to describe various components and methods, one skilled in the art will recognize that such terminology is intended to be descriptive and not limiting. By way of example, the term base station is intended to refer to a device which provides access to a network, and the term femto access point is intended to refer to a device which provides access to a lower-level network within the network serviced by the base station. Similarly, the phrase “wireless device” is intended to refer to any type of device which can transmit or receive data on the network. It will be understood that these phrases are intended to apply to multiple different wireless networking standards and to networking standards and configurations not yet described or implemented.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method to manage data transmission from a wireless device, comprising:
mapping a first set and at least one redundant set of physical uplink control channel (PUCCH) blocks into a subframe structure, wherein the at least one redundant set of PUCCH blocks is embedded in an interior section of the subframe; and
transmitting the subframe structure.

2. The method of claim 1, wherein mapping a first set and at least one redundant set of physical uplink control channel (PUCCH) blocks into a subframe structure comprises:
determining a number of clusters in a modulation scheme implemented by wireless device; and:
constructing a PUCCH subframe in accordance with the number of clusters.

3. The method of claim 2, wherein:
the wireless device implements a clustered single carrier frequency division multiple access modulation scheme; and
the at least one redundant set of PUCCH blocks is embedded into the center of a clustered subframe.

4. The method of claim 1, further comprising:
receiving a feedback signal from a wireless networking station that received the PUCCH blocks in a data transmission; and
modifying the number of redundant copies of PUCCH blocks in the subframe structure in response to the feedback signal.

5. The method of claim 4, wherein modifying the number of redundant copies of PUCCH blocks in the subframe structure in response to the feedback signal comprises increasing the number of redundant copies of PUCCH blocks such that the total number of PUCCH blocks transmitted corresponds to a number of clusters in the modulation scheme.

6. A wireless device, comprising:
a signal processor;
a control module coupled to the signal processor and comprising logic to map a first set and at least one redundant set of physical uplink control channel (PUCCH) blocks into a subframe structure, wherein the at least one redundant set of PUCCH data is embedded in the center of the subframe;
a transmitter coupled to the signal processor to transmit the PUCCH blocks.

7. The wireless device of claim 6, wherein the control module further comprises logic to:
determine a number of clusters in a modulation scheme implemented by wireless networking station; and:
construct a PUCCH subframe in accordance with the number of clusters.

8. The wireless device of claim 7, wherein:
the wireless device implements a clustered single carrier frequency division multiple access modulation scheme.

9. The wireless device of claim 6, wherein the control module further comprises logic to:
receive a feedback signal from a wireless networking station that received the PUCCH blocks in a data transmission; and
modify the number of redundant copies of PUCCH data in the subframe structure in response to the feedback signal.

10. The wireless device of claim 9, wherein the control module further comprises logic to:
increase the number of redundant copies of PUCCH blocks such that the total number of PUCCH blocks transmitted corresponds to a number of clusters in the modulation scheme.

11. A controller comprising logic to:
determine a number of clusters in a clustered single carrier frequency division multiple access modulation scheme implemented by a wireless device;
construct a physical uplink control channel (PUCCH) subframe in accordance with the number of clusters; and
map a first set and at least one redundant set of PUCCH blocks into the PUCCH subframe structure, wherein the at least one redundant set of PUCCH data is embedded in an interior section of the subframe

12. The controller of claim 11, wherein the at least one redundant set of PUCCH blocks is embedded into the center of a clustered subframe.

13. The controller of claim 11, wherein the controller further comprises logic to:
receive a feedback signal from a wireless networking station that received the PUCCH data in a data transmission; and
modify the number of redundant copies of PUCCH blocks in the subframe structure in response to the feedback signal.

14. The controller of claim 13, further comprising logic to increase the number of redundant copies of PUCCH blocks such that the total number of PUCCH data sets transmitted corresponds to a number of clusters in the modulation scheme.

15. The controller of claim 11, further comprising:
an RF modulator/demodulator coupled to the controller to modulate/demodulate the PUCCH data for communication within a predetermined frequency range; and
a transmitter to transmit the PUCCH blocks.

16. A method, comprising:
determining a number of clusters in a clustered single carrier frequency division multiple access modulation scheme implemented by a wireless device; and:
constructing a physical uplink control channel (PUCCH) subframe in accordance with the number of clusters; and
mapping a first set and at least one redundant set of PUCCH blocks into the PUCCH subframe structure, wherein the at least one redundant set of PUCCH data is embedded in an interior section of the subframe.

17. The method of claim 16, wherein the at least one redundant set of PUCCH blocks is embedded into the center of a clustered subframe.

18. The method of claim 16, further comprising:
receiving a feedback signal from a wireless networking station that received the PUCCH blocks in a data transmission; and
modifying the number of redundant copies of PUCCH blocks in the subframe structure in response to the feedback signal.

19. The method of claim 18, further comprising increasing the number of redundant copies of PUCCH blocks such that the total number of PUCCH data sets transmitted corresponds to a number of clusters in the modulation scheme.

20. The method of claim 16, further comprising:
modulating PUCCH blocks for communication within a predetermined frequency range; and
transmitting the PUCCH blocks.
